(19) United States
(12) Patent Application Publication
(10) Pub. No.: US 2008/0232402 A1
(43) Pub. Date: Sep. 25, 2008

(54) COMMUNICATION RELAY APPARATUS, RESOURCE RELEASING METHOD, AND PROGRAM FOR COMMUNICATION RELAY APPARATUS

(76) Inventors: NAOSHI HIGUCHI, Tokyo (JP); Tutomu Murase, Tokyo (JP)

Correspondence Address: Jackson Chen;NEC Corporation of America, 6535 N. State Hwy. 161, Irving, TX, 75039, US

(21) Appl. No.: 12/050,361

(22) Filed: Mar. 18, 2008

(30) Foreign Application Priority Data
Mar. 22, 2007 (JP) JP2007-074684

(51) Int. Cl. H04J 3/16

(52) U.S. Cl. 370/469

(57) ABSTRACT

Suspendable candidate link group determining device 204 determines a suspendable candidate link group consisting of communication links whose communication in an upper layer is suspended, and outputs it. Link-incapable-of-handling-suspension excluding device 205 removes a communication link to an adjacent relay apparatus incapable of handling a suspended status from the communication link group of suspendable candidates output by the suspendable candidate link group determining device 204 based on information stored in link suspension manager 203, to obtain a communication link group to be suspended, and outputs information indicating the communication link group to be suspended. Suspension device 206 releases communication resources for a lower layer for each communication link for the communication link group to be suspended, which is indicated by information output from the link-incapable-of-handling-suspension excluding device 205.

### INCORPORATION BY REFERENCE

This application is based upon and claims the benefit of priority from Japanese patent application No. 2007-074684, filed on Mar. 22, 2007, the disclosure of which is incorporated herein in its entirety by reference.

### RELATED ART

The present invention relates to a communication relay apparatus, a resource releasing method, and a program for the communication relay apparatus for use in a communication network, and more particularly, to a communication relay apparatus, a resource releasing method, and a program for the communication relay apparatus for making effective use of resources of a communication network equipment by, when an communication in an upper layer is suspended, releasing resources for a lower layer while retaining those for the upper layer.

A method for making effective use of resources (memory resources, allocated band resources, power resources, etc.) in a communication network equipment involves, taking account of a multi-layer structure of a communication protocol as designated by an OSI reference model, when communication in an upper layer comes into an idle status (in which no communication is initiated and no data is carried), shifting to a suspended status in which resources for a lower layer are released while retaining those for the upper layer. Moreover, when communication in the upper layer is out of the idle status, the method allocates resources for the lower layer again making use of resources for the upper layer that has been retained, and resumes communication in the upper layer (see Patent Document 1, for example).

As used herein, the term upper layer refers to a communication layer relayed by a communication network equipment, which represents a network layer in the OSI reference model in the communication network equipment. It should be noted that while the network layer in the OSI reference model implies a layer in connectionless-type communication such as IP communication, the network layer as used in this specification is not limited to such a layer in connectionless-type communication but is intended to encompass a layer in connection-type communication, such as, for example, a telephone communication line network.

As used herein, the term lower layer refers to a communication layer used by a communication network equipment in communication with an adjacent communication network equipment, and it represents a data communication link layer in the OSI reference model in the communication network equipment.

Moreover, the phrase “making effective use of resources” refer to, in a case of memory resources, for example, an operation involving releasing a memory allocated for a lower layer with respect to an upper layer in a suspended status to increase an available memory to be allocated for a lower layer with respect to another upper layer not in a suspended status. In a case of the allocated band resources, for example, it refers to an operation of relocating an allocated band to communication of a lower layer with respect to another upper layer not in a suspended status. In a case of power resources, for example, it refers to an operation of reducing the electricity rate.

A communication network equipment according to the technology disclosed in Patent Document 1 operates as follows: the communication network equipment monitors communication in an upper layer to decide whether the communication in the upper layer is in an idle status. The decision that communication in the upper layer is in an idle status is made, for example, according to whether a period of time in which the communication network equipment is not relaying communication in the upper layer is greater than a predetermined threshold.

When communication in the upper layer is decided to be in an idle status, the communication network equipment releases resources for a lower layer with respect to the upper layer in an idle status while retaining those for the upper layer without releasing them. In other words, the equipment is shifted to a suspended status. As for an upper layer of a connectionless type, resources for a lower layer are typically released while retaining a routing table for the upper layer. As for an upper layer of a connection type, resources for a lower layer are typically released while retaining a connection management table for the upper layer.

The connectionless type will now be described with an example. An example is taken in which a communication network equipment is a wireless router equipment that uses a wireless LAN in a lower layer and IP communication in an upper layer. The wireless router equipment suspends a wireless LAN communication link through which no IP packet has been carried over a period of time greater than a predetermined threshold, and releases resources for the wireless LAN (allocated band, owner management memory, etc.). Yet, it retains an IP routing table. When an IP packet that arrives thereafter is decided to be sent to the suspended wireless LAN communication link referring to the IP routing table, the suspended wireless LAN communication link is activated again, thus achieving an operation of relaying the IP packet.

The connection type will now be described with an example. An example is taken in which the communication network equipment is an HTTP proxy equipment that uses TCP/IP communication in a lower layer and HTTP communication in an upper layer. The HTTP proxy equipment disconnects a TCP connection in a lower layer in which no HTTP communication has been carried over a period of time greater than a predetermined threshold to thereby release resources for the TCP connection (port number, sequence number storing memory, window size storing memory). Yet, it retains resources for HTTP connection management (destination URL). When data is carried again through the HTTP connection, the data sender establishes a TCP connection again based on the HTTP connection management resources, thus achieving an operation of relaying the data on the HTTP connection.

In a communication network equipment that does not employ a technology of releasing resources for a lower layer while retaining those for an upper layer when communication in the upper layer comes into an idle status, lower layer resource release induces upper layer resource release. This occurs by an operation of, upon release of resources for a lower layer, delivering a signal to an upper layer considering the lower layer as being disconnected, and releasing resources for the upper layer. Thus, for an upper layer working with connectionless-type communication, a table entry corresponding to the lower layer is deleted from a routing table for the upper layer. For an upper layer working with connection-type communication, a connection management table entry corresponding to the lower layer is deleted from a connection management table in the upper layer.

[Patent Document 1] JP-P2002-519962A

The method for releasing resources for a lower layer while retaining those for an upper layer when communication in the upper layer comes into an idle status cannot make effective use of resources in a communication network in which equipments capable of handling a technology of “releasing resources for a lower layer while retaining those for an upper layer in synchronization with suspension (idle status) of the upper layer” (which will be referred to as a suspension technology hereinbelow) and those incapable of handling the technology are present together. In a case that a network equipment capable of handling a suspension technology and that incapable of handling the suspension technology are connected with each other over a communication link, once the network equipment capable of handling the suspension technology has released resources for a lower layer, the network equipment incapable of handling the suspension technology delivers, in response to the resource release for the lower layer, a signal to the upper layer indicating disconnection of the lower layer, thus releasing resources for the upper layer. As a result, it is impossible to attain a desired object that resources of the network equipment be effectively used by releasing resources for a lower layer while retaining those for an upper layer.

Hereinbelow, a communication path established by a lower layer between communication network equipments will be referred to as a “communication link.”

### SUMMARY OF THE INVENTION

The present invention is made to solve the above-mentioned problems.

Thus, it is an object of the present invention to provide effective use of resources of a communication relay apparatus as a communication network equipment in a communication network in which equipments capable of handling the suspension technology and those incapable of handling the suspension technology are present together.

A communication relay apparatus according to the present invention is characterized in that the apparatus includes: a suspendable candidate link group determining device for determining a communication link group consisting of communication links having suspended communication in an upper layer; a link-incapable-of-handling-suspension excluding device for excluding, from the communication link group determined by the suspendable candidate link group determining device, a communication link to an adjacent equipment not having suspension capability of releasing resources for a lower layer while retaining resources for an upper layer when communication in the upper layer is suspended, and outputting information indicating a communication link group consisting of communication links that are not excluded as information indicating a communication link group to be brought into a suspended status; and a suspending device for making control for each communication link in a communication link group indicated from the information output by the link-incapable-of-handling-suspension excluding device, to direct a lower layer protocol stack corresponding to each communication link to release resources for the lower layer.

According to a preferred aspect of the present invention, the communication relay apparatus is configured as follows: A link suspension manager stores suspendability of each communication link for all communication network equipments that this apparatus is adjacent to over a communication link, except this apparatus, based on whether the communication network equipment is capable of handling a suspension technology. A link status manager stores a status of a communication link for all communication links of this apparatus as one of “connected status,” “disconnected status,” and “suspended status.” A relay manager stores which communication link carries each of upper layer communication relayed by this apparatus.

The suspendable candidate link group determining device retrieves, when certain communication in an upper layer is suspended, a communication link through which the suspended communication in an upper layer has been carried, based on information stored in the relay manager and information stored in the link status manager, and outputs a communication link group obtained in a result of the retrieval as a suspendable candidate link group, which is a candidate whose communication link is to be brought into a suspended status and whose resources for the lower layer are to be released. The link-incapable-of-handling-suspension excluding device retrieves a communication link with an equipment incapable of handling a suspension technology based on information stored in the link suspension manager, excludes a communication link group obtained in a result of the retrieval from the suspendable candidate link group, and outputs it as a communication link group to be suspended.

The suspending device brings a communication link into a suspended status for each communication link contained in the communication link group to be suspended, and releases resources for a lower layer while retaining resources for an upper layer.

Also, a resumable link group determining device outputs information indicating a communication link group to be resumed when communication data is carried again in a suspended upper layer, based on information stored in the relay manager and information stored in the link status manager. A resuming device reserves resources for a lower layer again to resume the communication link for each communication link contained in the communication link group to be resumed. In other words, for the communication link contained in the communication link group to be resumed, resources are allocated again for a lower layer, and the communication link is validated again.

By means of the operation of each element as described above, a communication link between equipments capable of handling a suspension technology can be selectively brought into a suspended status to release resources for a lower layer corresponding to the communication link, and retain a communication link between an equipment capable of handling the suspension technology and an equipment incapable of handling the suspension technology without suspending the communication link, whereby resources for a lower layer for the equipment capable of handling the suspension technology can be released while retaining resources for an upper layer for both the equipment capable of handling the suspension technology and the equipment incapable of handling the suspension technology. Hence, resources of communication network equipments can be effectively used in a communication network in which equipments capable of handling the suspension technology and equipments incapable of handling the suspension technology are present together.

According to the present invention, in a communication network in which relay apparatuses capable of handling the suspension technology and relay apparatuses incapable of handling the suspension technology are present together, when communication in an upper layer is suspended, resources for a communication link to an adjacent relay apparatus capable of handling the suspension technology are released out of resources for a lower layer corresponding to the suspended upper layer, whereby resources can be effectively used.

### BRIEF DESCRIPTION OF THE DRAWINGS

This and other objects, features and advantages of the present invention will become more apparent upon a reading of the following detailed description and drawings, in which:

FIG. 1 is a block diagram showing a relay apparatus in accordance with a first embodiment of the present invention;

FIG. 2 is a block diagram showing an exemplary configuration of suspension manager;

FIG. 3 is an explanatory diagram showing an overview of an operation of the relay apparatus in a UML activity diagram format;

FIG. 4 is an explanatory diagram showing a determining operation by suspendable candidate link group determining device in a UML activity diagram format;

FIG. 5 is an explanatory diagram showing a determining operation by resumable link group determining device in a UML activity diagram format;

FIG. 6 is an explanatory diagram showing an operation of the relay apparatus in a communication network in which relay apparatuses incapable of handling a suspended status are present in a mixed manner in accordance with the first embodiment;

FIG. 7 is an explanatory diagram showing a determining operation by the suspendable candidate link group determining device in a UML activity diagram format in accordance with a second embodiment;

FIG. 8 is an explanatory diagram showing a determining operation by the resumable link group determining device in a UML activity diagram format; and

FIG. 9 is an explanatory diagram showing an operation of the relay apparatus in a communication network in which relay apparatuses incapable of handling a suspended status are present in a mixed manner in accordance with the second embodiment.

### EXEMPLARY EMBODIMENTS

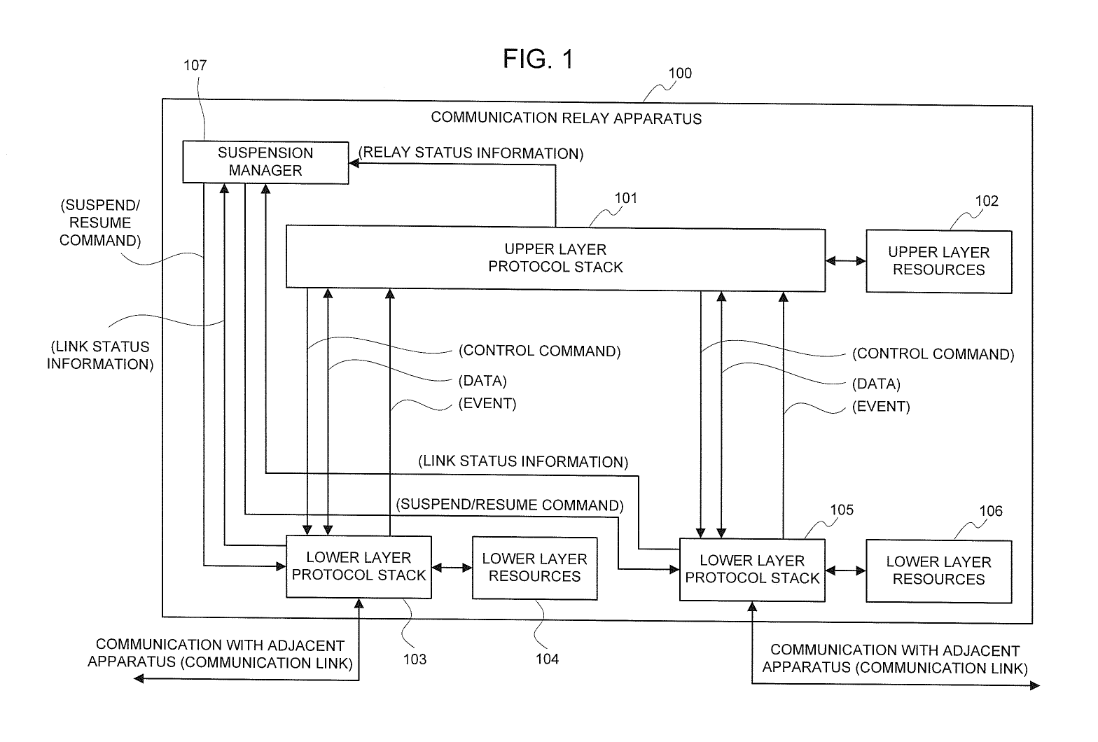

Next, exemplary embodiments of the present invention will be described in detail with reference to the accompanying drawings. FIG. 1 is a block diagram showing a communication relay apparatus (which will be referred to as a relay apparatus hereinbelow) in accordance with a first exemplary embodiment of the present invention. A relay apparatus 100 shown in FIG. 1 comprises an upper layer protocol stack 101, upper layer resources 102, a lower layer protocol stack 103, lower layer resources 104 and 106, a lower layer protocol stack 105, and suspension manager 107.

The relay apparatus 100 communicates with an adjacent communication relay apparatus via the lower layer protocol stack 103 and lower layer protocol stack 105. Specifically, communication is relayed by transmitting/receiving data, involving the upper layer protocol stack 101 directing a control command to the lower layer protocol stack 103 and lower layer protocol stack 105, and receiving a response, an event of communication disconnection, etc., from the lower layer protocol stack 103 and lower layer protocol stack 105. Each communication link connected to the relay apparatus 100 is assumed to be assigned with a unique communication link identifier within the apparatus for identification. While a configuration comprising two communication links is illustrated in FIG. 1, there may be three or more communication links connected to a relay apparatus. Moreover, a lower layer and an upper layer represent a relative concept.

It may be contemplated that the relay apparatus 100 is an IP router equipment, for example, that employs Ethernet communication for communication in a lower layer and IP communication for communication in an upper layer. It may also be contemplated that the relay apparatus 100 is an HTTP proxy equipment, for example, that employs TCP communication for communication in a lower layer and HTTP communication for communication in an upper layer.

The upper layer protocol stack 101 operates to relay connectionless-type communication, and uses upper layer resources 102 for the operation. The upper layer resources 102 represent a concept encompassing memories, allocated bands, power, etc. Likewise, the lower layer protocol stack 103 uses the lower layer resources 104, and the lower layer protocol stack 105 uses the lower layer resources 106. Once the upper layer protocol stack 101 has released its resources, the relay apparatus becomes unable to relay communication in an upper layer, and communication in an upper layer is disconnected. Once the lower layer protocol stack 103 or lower layer protocol stack 105 has released its resources, the relay apparatus becomes unable to conduct communication in a lower layer, and communication in a lower layer is disconnected.

The suspension manager 107 receives relay status information on communication in an upper layer from the upper layer protocol stack 101. The relay status information includes identification information about a communication link through which the relayed communication in an upper layer is established, and suspension/non-suspension information on communication in an upper layer. The suspension manager 107 sends a suspend command and a resume command to the lower layer protocol stacks based on the relay status information. On receipt of a suspend command from the suspension manager 107 within this apparatus, the lower layer protocol stack 105 sends a suspend command to an adjacent relay apparatus via a communication link, and then, releases lower layer resources that the stack 105 itself is using, without sending a communication disconnection event to the upper layer protocol stack 101. It should be noted that the suspend command sent by the suspension manager 107 within this apparatus and that sent to an adjacent relay apparatus may not necessarily be in the same format.

On receipt of the suspend command from the adjacent relay apparatus via the communication link, and when the communication link is disconnected by the adjacent relay apparatus immediately thereafter, the lower layer protocol stack 105 releases lower layer resources that it has been using without sending a communication disconnection event to the upper layer protocol stack 101.

In a case that disconnection of a communication link is not caused by a suspend command, that is, in a case that the lower layer protocol stack detects some communication anomaly or an adjacent relay apparatus disconnects a communication link without any suspend command, the lower layer protocol stack 105 releases its lower layer resources and sends a communication disconnection event to the upper layer protocol stack 101. At that time, the upper layer protocol stack 101 should address the case by releasing disconnected resources in communication in an upper layer, or bypassing a communication path in the upper layer to another communication link, or the like.

On receipt of a resume command from the suspension manager 107 within this apparatus, the lower layer protocol stack reserves lower layer resources again, and connects a communication link with an adjacent relay apparatus.

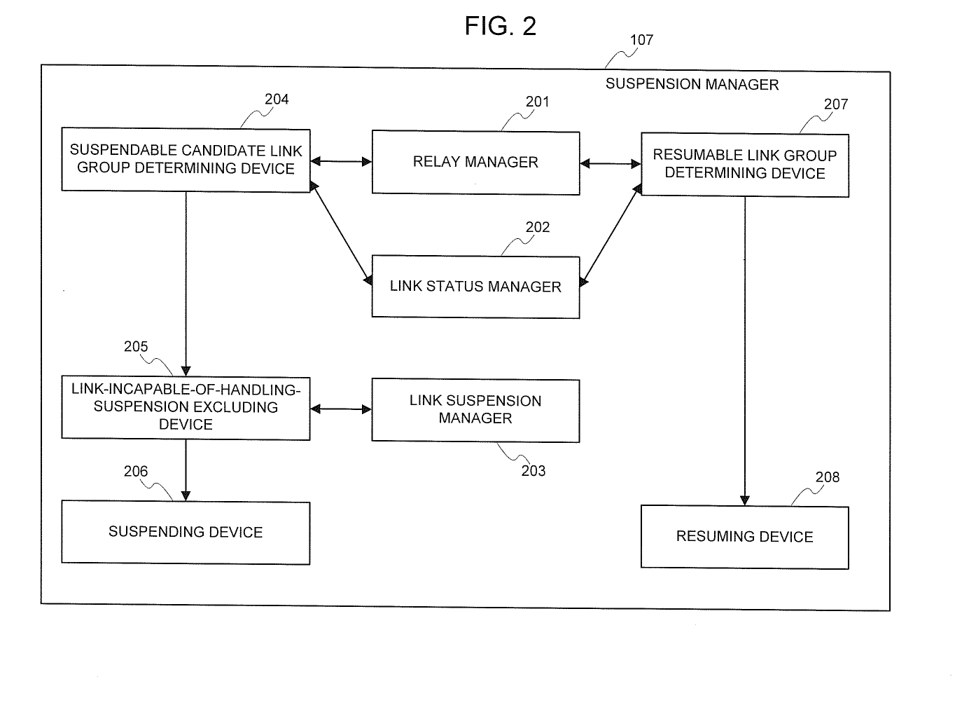

FIG. 2 is a block diagram showing an exemplary configuration of the suspension manager 107. The suspension manager 107 shown in FIG. 2 comprises relay manager 201, link status manager 202, link suspension manager 203, suspendable candidate link group determining device 204, link-incapable-of-handling-suspension excluding device 205, suspending device 206, resumable link group determining device 207, and resuming device 208.

The relay apparatus may be configured to include a CPU for control according to a program and several devices within the suspension manager 107 may be implemented by software.

The relay manager 201 stores conditions of communication relayed by this apparatus based on relay status information received from the upper layer protocol stack 101. The storage is updated any time on receipt of relay status information from the upper layer protocol stack 101. The information stored in the relay manager 201 forms a table in which a set of a communication link identifier and time information on arrival of communication data in an upper layer through that communication link at this relay apparatus is arranged for all communication link identifiers. For certain communication in an upper layer, and when its corresponding communication link is employed on an input side of the communication in an upper layer, a corresponding set of a communication link identifier and time information indicates that “data in an upper layer is carried through a communication link designated by the communication link identifier, and this relay apparatus receives that data at a time indicated by the time information.” For certain communication in an upper layer, and when its corresponding communication link is specified on an output side of the communication in an upper layer, a corresponding set of a communication link identifier and time information indicates that “data in an upper layer received by this relay apparatus at a time indicated by time information is waiting for transmission in this relay apparatus, and is scheduled to be transmitted by this relay apparatus through a communication link designated by the communication link identifier.”

The relay status information is transmitted from the upper layer protocol stack 101 at intervals of a certain period of time. The relay status information contains an identifier of a communication link through which data in an upper layer has been carried from a time of creation of immediately preceding relay status information to the current time, and an identifier of a communication link through which data in an upper layer currently buffered in the upper layer protocol stack 101 is scheduled to be transmitted in the future.

The link status manager 202 stores conditions of communication links based on communication link status information received from the lower layer protocol stack. The condition of a communication link includes three statuses, i.e., a connected status, a disconnected status, and a suspended status. The connected status refers to a condition in which resources are allocated for both of upper and lower layers. The suspended status refers to a condition in which when communication in an upper layer is suspended, i.e., it comes into an idle status, resources for the lower layer are released while retaining those for the upper layer, as described earlier. However, some kinds of the lower layer protocol stacks may not require discrimination between a disconnected status and a suspended status, and in such a case, the condition may include two statuses, i.e., a connected status and a disconnected status. Information stored in the link status manager 202 forms a table in which a set of a communication link identifier and a condition of the communication link is arranged for all communication link identifiers.

The link suspension manager 203 stores whether each communication link is suspendable or not in the form of a table in which a set of a communication link identifier and a Boolean value indicating suspendability is arranged for all communication link identifiers. In a case that apparatuses at both ends of a communication link are capable of coming into a suspended status, the communication link is a suspendable communication link (a communication link capable of coming into a suspended status).

Several methods can be considered as a method of deciding whether a communication link is suspendable or not. For example, it may be contemplated that the decision be predetermined to the relay apparatus 100 as setting information. In particular, the setting information is for indicating whether an adjacent equipment has capability of releasing resources for a lower layer. Alternatively, it may be contemplated that the decision be made from a property of communication in a lower layer. The decidability from a property of communication in a lower layer refers to, for example, ability that information on a version of communication equipment specification of a corresponding equipment (an adjacent equipment in view of the relay apparatus 100) is contained in communication header information as a property of a protocol of communication in a lower layer, and decision can be made from the version of specification as to whether the equipment is capable of handling a suspended status, i.e., whether the equipment has suspension capability with which the equipment can be brought into a suspended status. Moreover, for example, communication equipment specification in a lower layer may include whether it is possible to address inquiry about suspension capability to that equipment (an adjacent equipment in view of the relay apparatus 100). When it is possible to address inquiry about suspension capability, the relay apparatus 100 delivers an inquiry to an adjacent equipment via communication, and stores a response from the adjacent equipment into the link suspension manager 203.

It may be contemplated that in some cases the link-incapable-of-handling-suspension excluding device 205 cannot definitively decide whether an adjacent equipment is suspendable. For example, in a case that it is not mandatory for a lower layer protocol to incorporate information on a version of specification into communication header information but the information may be optionally incorporated, it is not possible to decide that an adjacent equipment is capable of handling a suspended status or that an adjacent equipment is incapable of handling the status. In such a case, the corresponding adjacent communication equipment may be decided to be incapable of handling a suspended status. In that case, effective use of resources cannot be attained, although erroneous disconnection of a communication path can be prevented at a time of suspension of communication in an upper layer.

The suspendable candidate link group determining device 204 outputs a suspendable candidate communication link group based on information stored in the relay manager 201 and that stored in the link status manager 202. The suspendable candidate communication link group can be expressed as a set of communication link identifiers. A criterion for selection of a suspendable candidate is based on whether a period of time from a time at which communication data in an upper layer has been carried finally to a time of selection is greater than a predetermined threshold or not.

The link-incapable-of-handling-suspension excluding device 205 removes a communication link to an adjacent relay apparatus that is incapable of handling a suspended status from the suspendable candidate communication link group output from the suspendable candidate link group determining device 204 based on information stored in the link suspension manager 203 to obtain a communication link group to be suspended, and outputs information indicating the communication link group to be suspended.

The suspending device 206 sends, for each communication link in the communication link group to be suspended indicated by the information output from the link-incapable-of-handling-suspension excluding device 205, a suspend command to a lower layer protocol stack corresponding to that communication link to direct it to release communication resources for a lower layer.

The resumable link group determining device 207 determines a communication link group to be resumed based on information stored in the relay manager 201 and that stored in the link status manager 202, and outputs information indicating the communication link group to be resumed. The information indicating a communication link group to be resumed is expressed as a set of communication link identifiers. A criterion for selection of a communication link group to be resumed is a communication link in a suspended status based on information stored in the link status manager 202 among communication links through which data in an upper layer is scheduled to be carried based on information stored in the relay manager 201. In a case that a communication link through which data is to be transmitted is in a suspended status while the upper layer is receiving data, the upper layer protocol stack 101 buffers data and waits for transmission until the suspension manager 107 resumes a communication link.

The resuming device 208 sends, for each communication link in the communication link group indicated by information output from the resumable link group determining device 207 (communication link group to be resumed), a resume command to a lower layer protocol stack corresponding to that communication link to direct it to reserve again communication resources for a lower layer.

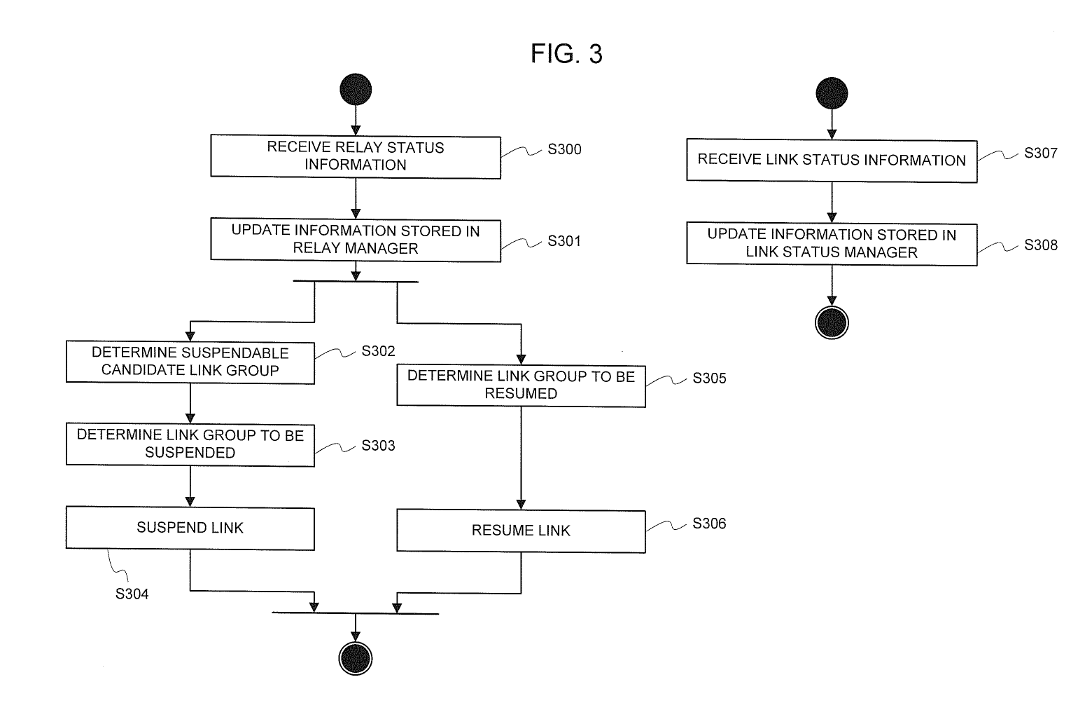

Next, an operation of the relay apparatus in accordance with the first embodiment of the present invention will be described with reference to the accompanying drawings. Referring to FIG. 3, an overview of an operation of the relay apparatus is shown in a UML activity diagram format. When the suspension manager 107 receives relay status information from the upper layer protocol stack 101 (Step S300 in FIG. 3), the relay manager 201 first updates its stored information based on the received relay status information and a current time (Step S301). Next, the suspendable candidate link group determining device 204 determines a suspendable candidate link group (Step S302). A determining operation by the suspendable candidate link group determining device 204 will be discussed later.

Next, the link-incapable-of-handling-suspension excluding device 205 removes an unsuspendable communication link from the suspendable candidate link group determined by the suspendable candidate link group determining device 204, and determines a communication link group to be suspended (Step S303). Then, the suspending device 206 sends, for each communication link contained in the communication link group to be suspended determined by the link-incapable-of-handling-suspension excluding device 205, a suspend command to a corresponding lower layer protocol stack. On receipt of the suspend command, the lower layer protocol stack releases lower layer resources and suspends the communication link (Step S304).

The resumable link group determining device 207 determines a communication link group to be resumed (Step S305). A determining operation by the resumable link group determining device 207 will be discussed later.

Next, the resuming device 208 sends, for each communication link contained in the communication link group to be resumed determined by the resumable link group determining device 207, a resume command to a corresponding lower layer protocol stack. On receipt of the resume command, the lower layer protocol stack reserves lower layer resources again and resumes the communication link (Step S306).

It should be noted that a series of processing from Step S302 to Step S304 or that from Step S305 to Step S306 may be executed first, or they may be executed in parallel. Moreover, when several functions of a relay apparatus are implemented by software, the processing may be executed as pseudo-parallel processing by task switching.

When the suspension manager 107 has received communication link status information from a lower layer protocol stack (Step S307 in FIG. 3), the link status manager 202 updates its stored information based on the received communication link status information (Step S308).

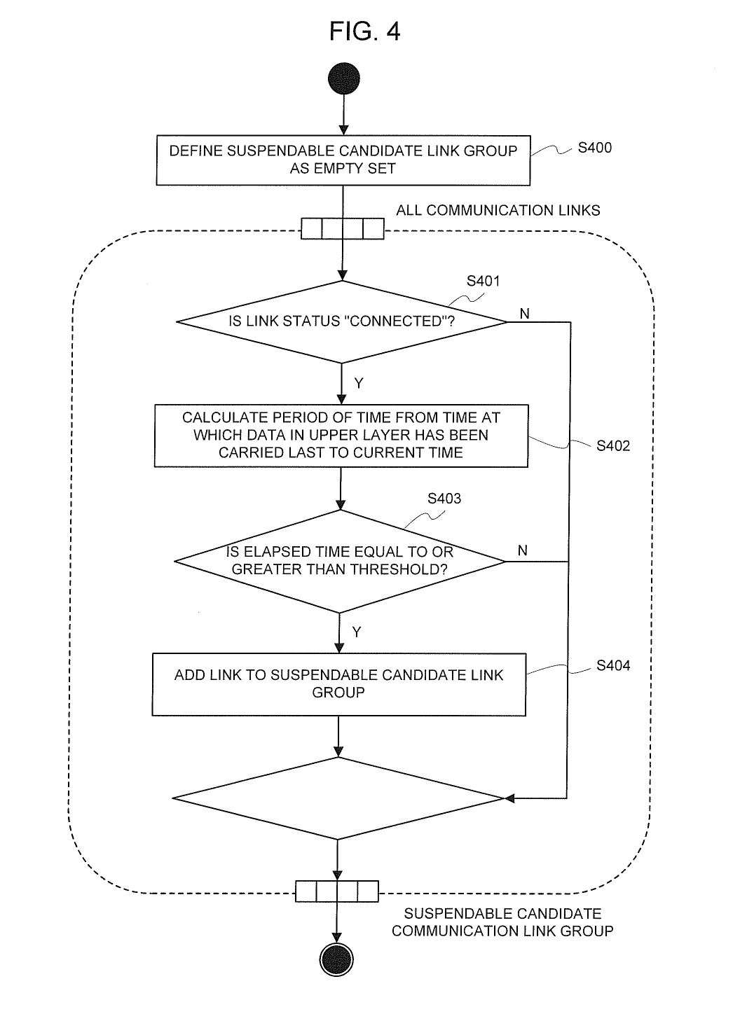

Referring to FIG. 4, an exemplary determining operation (Step S302) by the suspendable candidate link group determining device 204 is shown in a UML activity diagram format. The suspendable candidate link group determining device 204 first defines an empty set as an initial value of a suspendable candidate link group (Step S400). Next, it executes the following processing for each of all communication links (communication links established by a protocol in a lower layer) that are connected to this apparatus.

Specifically, the suspendable candidate link group determining device 204 checks whether the status of a communication link is a connected status based on information stored in the link status manager 202 (information indicating a condition of communication that this apparatus relays based on relay status information received from the upper layer protocol stack 101) (Step S401). In a case that it is not in a connected status, processing for that communication link is terminated. In a case that it is in a connected status, the suspendable candidate link group determining device 204 calculates a period of time in which no data is carried through the communication link. In particular, it obtains a current time, obtains a time at which data has been carried through the communication link last based on information stored in the relay manager 201, and subtracts the time at which data has been carried last from the current time to thereby calculate a period of time in which no data is carried through the communication link (Step S402).

Next, the suspendable candidate link group determining device 204 checks whether the calculated elapsed time is equal to or greater than a predetermined threshold or not. In a case that the elapsed time is not equal to or greater than the threshold (is less than the threshold), processing for that communication link is terminated (Step S403). In a case that the elapsed time is equal to or greater than the threshold, the communication link is decided to be that whose communication in an upper layer is suspended, and adds the communication link to a suspendable candidate link group as a candidate communication link that is to be brought into a suspended status (Step S404).

By means of the operation as shown in FIG. 4, the suspendable candidate link group determining device 204 determines a suspendable candidate link group consisting of communication links whose communication in an upper layer is suspended, and outputs information indicating the suspendable candidate link group.

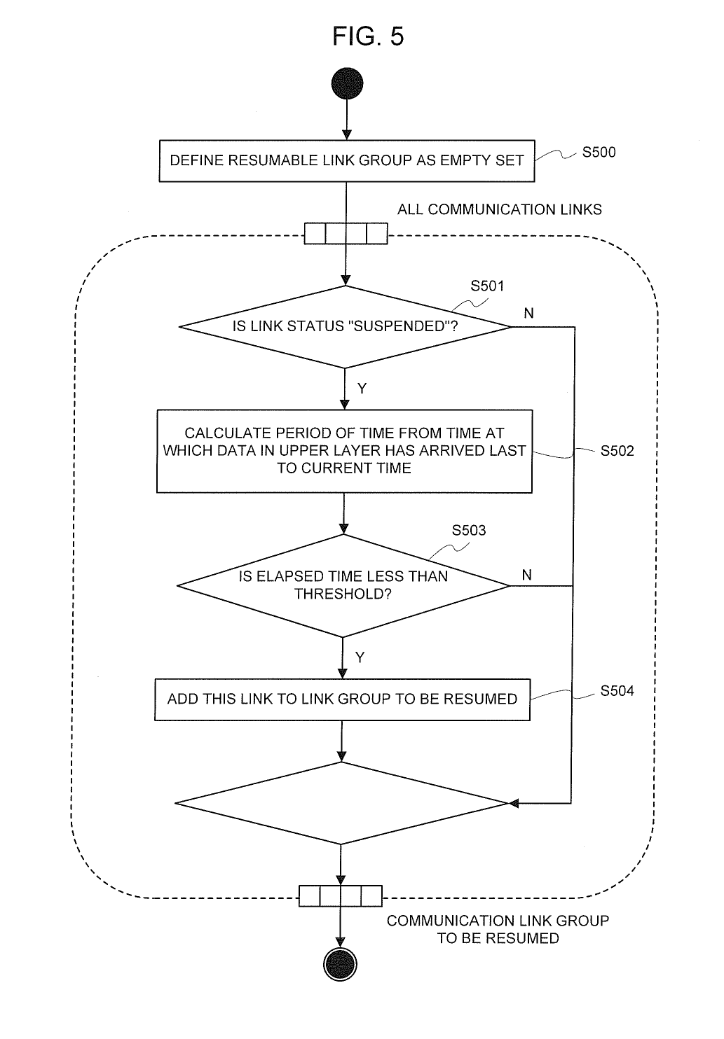

Referring to FIG. 5, an exemplary determining operation (Step S305) by the resumable link group determining device 207 is shown in a UML activity diagram format. The resumable link group determining device 207 first defines an empty set as an initial value of a communication link group to be resumed (Step S500). Next, it executes the following processing for each of all communication links that are connected to the present apparatus.

Specifically, the resumable link group determining device 207 checks whether the status of a communication link is a suspended status based on information stored in the link status manager 202 (Step S501). In a case that it is not in a suspended status, processing for that communication link is terminated.

In a case that it is in a suspended status, the resumable link group determining device 207 calculates an elapsed time from arrival of data that should be carried through a communication link. In particular, it obtains a current time, obtains a time at which data that should be carried through a communication link has arrived at the relay apparatus last based on information stored in the relay manager 201, and subtracts the time at which data has been carried last from the current time to thereby calculate an elapsed time from the latest arrival of data that should be carried through a communication link (Step S502).

Next, the resumable link group determining device 207 checks whether the calculated elapsed time is less than a predetermined threshold. In a case that it is not less than the threshold (is equal to or greater than the threshold), processing for that communication link is terminated (Step S503). In a case that it is less than the threshold, the resumable link group determining device 207 adds the communication link to a communication link group to be resumed (Step S504).

It should be noted that transmission of relay status information from the upper layer protocol stack 101 to the suspension manager 107 may be achieved either in the form of notification by the upper layer protocol stack 101 or in the form of inquiry by the suspension manager 107. However, a cycle of transmission of the relay status information must be shorter than a predetermined threshold. Moreover, transmission of communication link status information from the lower layer protocol stack to the suspension manager 107 may be achieved either in the form of notification by the lower layer protocol stack or in the form of inquiry by the suspension manager 107. However, a cycle of transmission of the communication link status information must be shorter than a predetermined threshold.

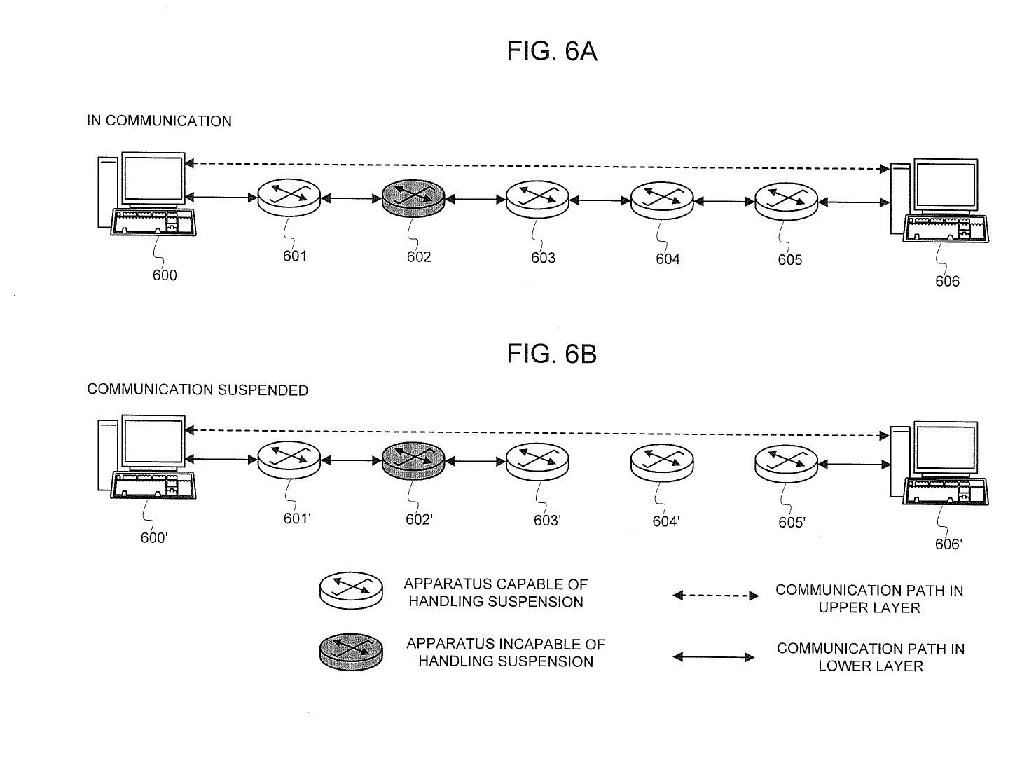

FIG. 6 is an explanatory diagram showing an operation of the relay apparatus in the present embodiment in a communication network in which relay apparatuses capable of handling a suspended status (a condition of “releasing resources for a lower layer while retaining those for an upper layer in synchronization with suspension of the upper layer”) and those incapable of handling the status, i.e., relay apparatuses not having suspension capability, are present together. In an example shown in FIG. 6, a condition in which communication in an upper layer is established between an end node 600 and an end node 606 is denoted as “In communication.”

A relay apparatus 601, a relay apparatus 603, a relay apparatus 604, and a relay apparatus 605 are relay apparatuses of this embodiment. The relay apparatus 602 is assumed to be a relay apparatus incapable of handling a suspended status. While the end node 600 and end node 606 are equipments incapable of handling a suspended status, in a case that it is desirable to assume the end node 600 to be an equipment capable of handling a suspended status, for example, the case may be addressed by regarding the end node 600 incapable of handling a suspended status and relay apparatus 601 as being accommodated in the same housing.

In a condition shown in FIG. 6A, all communication links between the relay apparatus 601, relay apparatus 602, relay apparatus 603, relay apparatus 604, relay apparatus 605, and end node 606 are in a connected status, and a communication path in an upper layer from the end node 600 to the end node 606 is established.

A condition shown in FIG. 6B is one in which communication in an upper layer is suspended between an end node 600′ and an end node 606′, i.e., in a status denoted as “Suspended.” In FIG. 6B, equipments in a suspended status are appended with a symbol “′”. In other words, an equipment denoted by a symbol “n′” in FIG. 6B is the same as that denoted by a symbol “n” in FIG. 6A.

A communication link between the relay apparatus 603′ and the relay apparatus 604′, and that between the relay apparatus 604′ and the relay apparatus 605′ have communication links in a suspended status according to the technology of this embodiment, and lower layer resources for these communication links are saved.

Communication links between the end node 600′ and the relay apparatus 601′, between the relay apparatus 601′ and the relay apparatus 602′, between the relay apparatus 602′ and the relay apparatus 603′, and between the relay apparatus 605′ and the end node 606′ are in a connected status. Hence, the end nodes 600′ and 606′ and the relay apparatus 602′ incapable of handling a suspended status do not release their communication resources in an upper layer. As a result, the communication path in an upper layer between the end node 600′ and the end node 606′ remains retained.

The saved lower layer resources may be used in other portions within the relay apparatus. Power resources, for example, may remain saved to reduce the electricity rate. The present embodiment attains a desired object of making effective use of resources while retaining a communication path in an upper layer.

Next, a second embodiment of the present invention will be described. a difference from the first embodiment will be discussed hereinbelow. The difference between the first embodiment and this embodiment is that in this embodiment, communication in an upper layer to be relayed is of a connection type while the first embodiment addresses connectionless-type communication.

Information stored in the relay manager 201 forms a table in which a set of a connection identifier, a communication link identifier group of communication links carrying connection, and information on a time at which communication data in an upper layer was relayed last in a connection, is arranged for all connection identifiers. The communication link identifier group of communication links may consist of two communication link identifiers for connection having no branching, or consist of three or more communication link identifiers for branching connection.

An operation according to the second embodiment of the present invention will now be described. An overview of the operation in the second embodiment is similar to that in the first embodiment. In other words, it is similar to the operation shown in FIG. 3 in a UML activity diagram format.

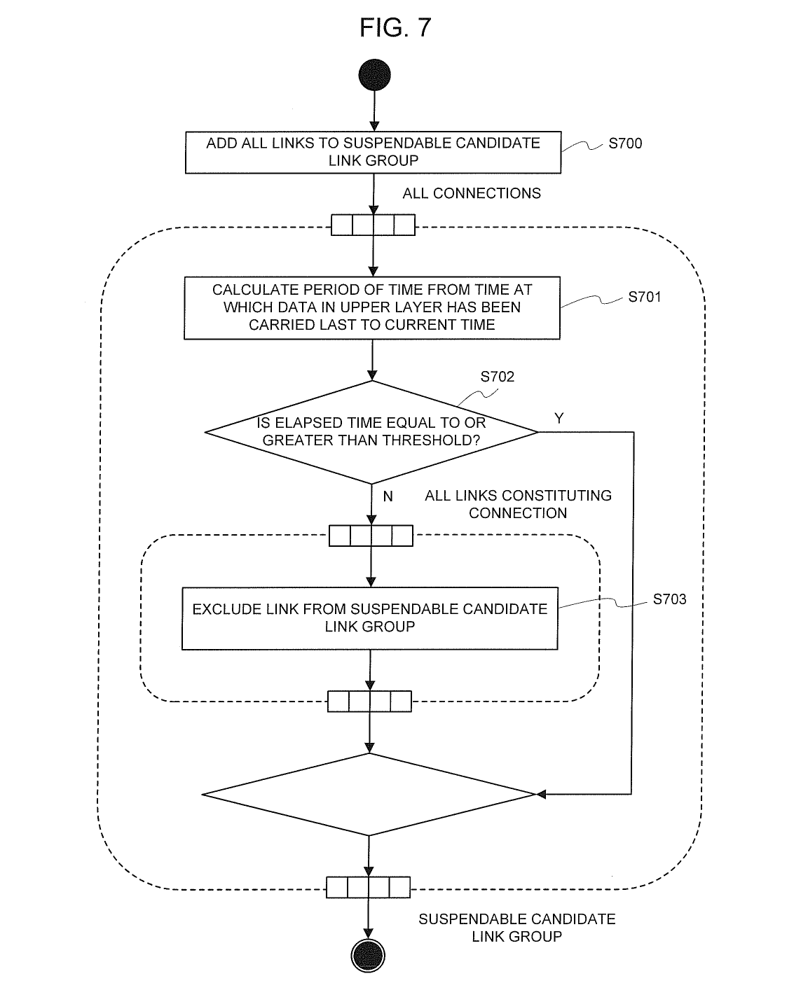

Referring to FIG. 7, a determining operation (Step S302) by the suspendable candidate link group determining device 204 according to this embodiment is shown in a UML activity diagram format. In this embodiment, the suspendable candidate link group determining device 204 first defines a set of all communication links that are connected to this apparatus as an initial value of a suspendable candidate link group (Step S700). Next, it executes the following processing for each of all connections (communication connections established by a protocol in an upper layer) that this apparatus relays.

First, the suspendable candidate link group determining device 204 calculates a period of time in which no data is carried through a communication link. In particular, it obtains a current time, obtains a time at which data has been carried through the communication link last based on information stored in the relay manager 201, and subtracts the time at which data has been carried last from the current time to thereby calculate a period of time in which no data is carried through the communication link (Step S701).

Next, a check is made as to whether the calculated elapsed time is equal to or greater than a predetermined threshold or not. In a case that the elapsed time is equal to or greater than the threshold, processing for that connection is terminated (Step S702). In a case that the elapsed time is not equal to or greater than the threshold (is less than the threshold), the communication link is excluded from the suspendable candidate link group for each of all communication links constituting the connection (Step S703). According to the aforementioned operation, the suspendable candidate link group determining device 204 outputs the suspendable candidate link group.

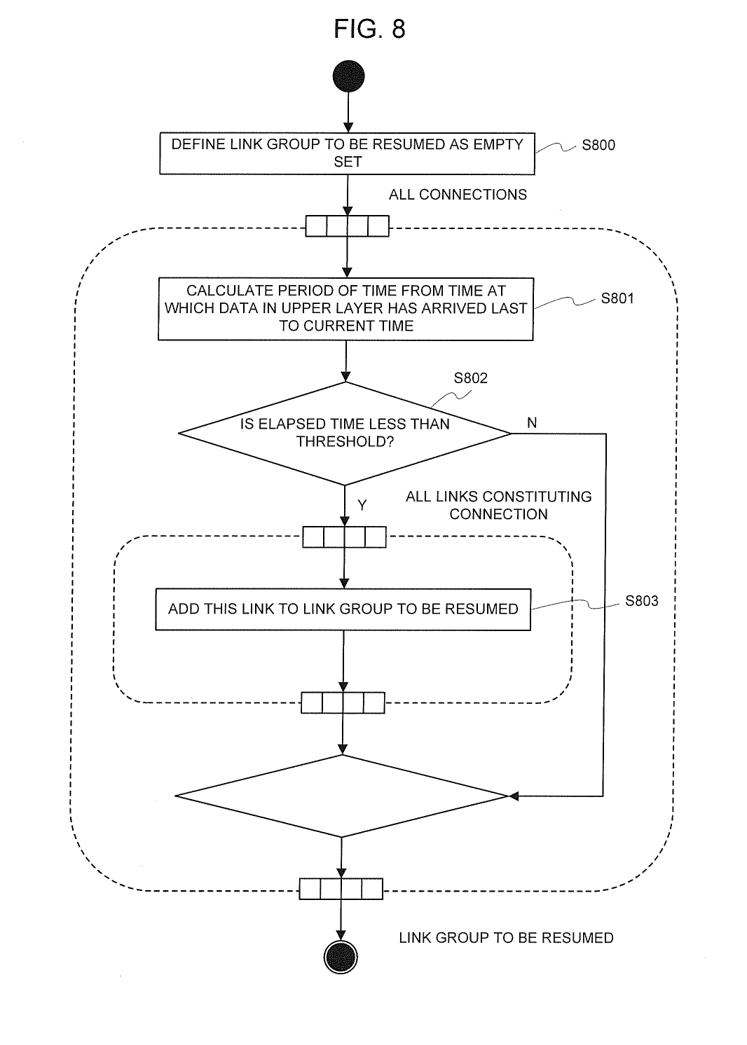

Referring to FIG. 8, a determining operation (Step S305) by the resumable link group determining device 207 in this embodiment is shown in a UML activity diagram format. According to this embodiment, the resumable link group determining device 207 first defines an empty set as an initial value of a communication link group to be resumed (Step S800). Next, it executes the following processing for each of all connections that this apparatus relays.

The resumable link group determining device 207 first calculates an elapsed time from the latest arrival of data that should be carried through a communication link. In particular, it obtains a current time, obtains a time at which data that should be carried through a communication link has arrived last based on information stored in the relay manager 201, and subtracts a time at which data has been carried last from the current time to thereby calculate an elapsed time from the latest arrival of data that should be carried through a communication link (Step S801).

Next, a check is made as to whether the calculated elapsed time is less than a predetermined threshold or not. In a case that it is equal to or greater than the threshold, processing for that connection is terminated (Step S802). In a case that the elapsed time is not equal to or greater than the threshold (is less than the threshold), the communication link is added to a communication link group to be resumed for each of all communications links constituting the connection (Step S803). According to the aforementioned operation, the resumable link group determining device 207 outputs the communication link group to be resumed.

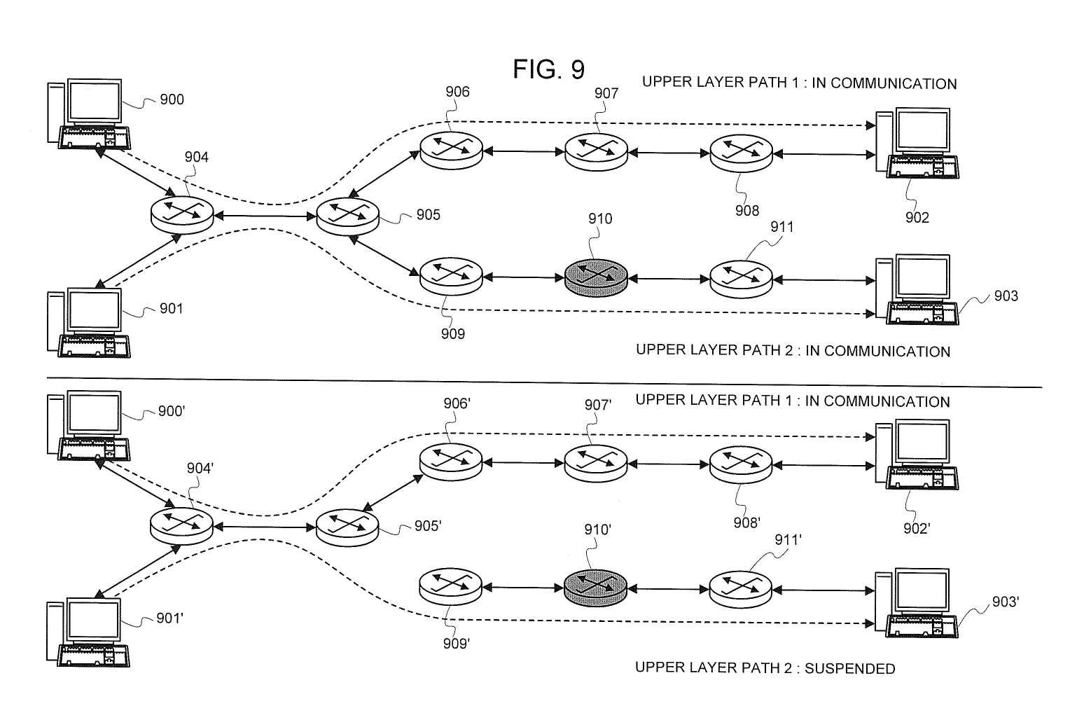

FIG. 9 is an explanatory diagram showing an operation of the relay apparatus in this embodiment in a communication network in which relay apparatuses capable of handling a suspended status (a condition of “releasing resources for a lower layer while retaining those for an upper layer in synchronization with suspension of the upper layer”) and those incapable of handling the status are present together.

In an upper portion of FIG. 9, a condition in which a connection in an upper layer is established between an end node 900 and an end node 902 and communication in an upper layer is carried therethrough is indicated as “Upper layer path 1: In communication.” A condition in which a connection in an upper layer is established between an end node 901 and an end node 903 and communication in an upper layer is carried therethrough is indicated as “Upper layer path 2: In communication.”

A relay apparatus 904, a relay apparatus 905, a relay apparatus 906, a relay apparatus 907, a relay apparatus 908, a relay apparatus 909, and a relay apparatus 911 are relay apparatuses of this embodiment. A relay apparatus 910 is assumed to be a relay apparatus incapable of handling a suspended status.

While the end node 900, the end node 901, the end node 902 and the end node 903 are assumed to be equipments incapable of handling a suspended status, in a case that it is desirable to assume the end node 902 to be an equipment capable of handling a suspended status, for example, the case may be addressed by regarding the end node 902 incapable of handling a suspended status and relay apparatus 908 as being accommodated in the same housing.

In the upper layer path 1, all communication links between the relay apparatus 904, the relay apparatus 905, the relay apparatus 906, the relay apparatus 907, the relay apparatus 908, and the end node 902 are in a connected status, and a communication path in an upper layer from the end node 900 to the end node 902 is established.

In the upper layer path 2, all communication links between the relay apparatus 904, the relay apparatus 905, the relay apparatus 909, the relay apparatus 910, the relay apparatus 911, and the end node 903 are in a connected status, and a communication path in an upper layer from the end node 901 to the end node 903 is established.

In the lower portion of FIG. 9, a condition in which communication in an upper layer is suspended between the end node 901′ and the end node 903′ is indicated as “Upper layer path 2: Suspended.” In the lower portion of FIG. 9, equipments are added with a symbol “′”, and an equipment denoted by a symbol “n′” is the same as that denoted by a symbol “n” in the upper portion of FIG. 9.

A communication link between the relay apparatus 905′ and the relay apparatus 909′ has a communication link in a suspended status according to the technology of this embodiment, and lower layer resources for that communication link are saved.

Communication links between the end node 901′ and the relay apparatus 904′, between the relay apparatus 909′ and the relay apparatus 910′, between the relay apparatus 910′ and the relay apparatus 911′, and between the relay apparatus 911′ and the end node 903′ are in a connected status. Hence, the end node 901′ and the relay apparatus 910′ incapable of handling a suspended status do not release communication resources in an upper layer. As a result, the communication path in an upper layer between the end node 901′ and the end node 903′ remains retained. Moreover, since the communication link between the relay apparatus 904′ and the relay apparatus 905′ is shared between the upper layer path 1 and the upper layer path 2, the communication link does not come into a suspended status even when the upper layer path 2 becomes suspended.

The saved lower layer resources may be used in other portions within the relay apparatus, or, for power resources, for example, they may remain saved to reduce the electricity rate. In this way, a desired object of making effective use of resources while retaining a communication path in an upper layer is attained.

Now an embodiment in which the present invention is applied to a relay apparatus employing connectionless-type communication will be described.

In an IP router for a communication network employing IP communication in communication in an upper layer and wireless LAN in communication in a lower layer, for a wireless LAN communication link through which an IP packet has not been carried beyond a predetermined threshold time, a wireless LAN connection between IP routers incorporating the present invention is suspended. This enables savings of power consumption in the wireless LAN. At that time, a routing table for the IP network that represents resources for an upper layer are retained without modification.

A wireless LAN communication link between an IP router not incorporating the present invention (an IP router not having suspension capability) and that incorporating the present invention is retained without modification. Hence, a routing table for the IP router not incorporating the present invention is retained without modification. In relaying an IP packet according to the retained routing table afterwards, when a need arises to establish a wireless LAN communication link that is suspended in the IP router incorporating the present invention, the wireless LAN communication link is connected again.

A plurality of methods may be contemplated for deciding whether an adjacent IP router incorporates the present invention. For example, there may be a method involving writing in an IP router incorporating the present invention IP addresses of IP routers incorporating the present invention except this router beforehand in a preset file. There may be another method involving, for example, writing MAC addresses instead of IP addresses in a preset file. There may be still another method involving, for example, adding a specific prefix to an SSID of an IP router incorporating the present invention as a mark, and setting an SSID for an IP router not incorporating the present invention not to have that prefix at the top of the SSID.

There may be an additional method involving, for example, inquiring of an adjacent relay apparatus about incorporation of the present invention using an SNMP (Simple Network Management Protocol), etc.

In an IP network, many of routers operate to update a routing table by communication between routers each time a certain period of time has expired. Accordingly, parameters relating to the present invention may be set so that the relationship represented by the following three inequalities is fulfilled, to thereby obtain a desired effect of the present invention:

T_{routing}>Tₜₕᵣₑₛₕ,

Tₜₕᵣₑₛₕ>Tₗₐₛₜ_{_{—}}ₜᵢₘₑ, and

Tₜₕᵣₑₛₕ>Tₗᵢₙₖ,

where the meanings of the parameters are as follows:

T_{routing}: a time interval of communication for updating a routing table,

Tₜₕᵣₑₛₕ: a predetermined threshold for use in decision as to whether a wireless LAN communication link is to be suspended,

Tₗₐₛₜ_{_{—}}ₜᵢₘₑ: a time interval for updating relay status information, and

Tₗᵢₙₖ: a time interval for updating communication link status information.

Next, an embodiment in which the present invention is applied to a relay apparatus employing connection-type communication will be described.

In an HTTP relay network having an end node on which an ordinary HTTP client (for example, a web browser) is running, an end node on which an ordinary HTTP server is running, and multi-stage HTTP proxies interposed between the web browser and HTTP server, and in which network the present invention is applied to part of the HTTP proxies, when no data is carried through HTTP communication in an upper layer beyond a predetermined threshold time, a TCP connection between the HTTP proxies incorporating the present invention is disconnected.

This enables reduction of the memory used in management of a TCP connection in an HTTP proxy. At that time, relay information (URL of connection destination) of the HTTP network representing resources for an upper layer is retained without modification. A TCP connection between an HTTP proxy not incorporating the present invention and that incorporating the present invention is retained without modification. Hence, in an HTTP proxy not incorporating the present invention, an HTTP connection is retained without being disconnected. Thereafter, when data is carried from either the HTTP client or HTTP server, the retained TCP connection is established again in the HTTP proxy incorporating the present invention.

In the HTTP network, an option to retain a connection between the HTTP client and the server even when no data is carried in HTTP communication over a certain period of time (Keep Alive option) may be sometimes employed. Accordingly, parameters relating to the present invention may be set so that the relationship represented by the following three inequalities is fulfilled, to thereby obtain a desired effect of the present invention:

Tₖₑₑₚ_{_{—}}ₐₗᵢᵥₑ>Tₜₕᵣₑₛₕ,

Tₜₕᵣₑₛₕ>Tₗₐₛₜ_{_{—}}ₜᵢₘₑ, and

Tₜₕᵣₑₛₕ>Tₗᵢₙₖ,

where the meanings of the parameters are as follows:

Tₖₑₑₚ_{_{—}}ₐₗᵢᵥₑ: a period of time specified by the Keep Alive option between an HTTP client and an HTTP server

Tₜₕᵣₑₛₕ: a predetermined threshold for use in decision as to whether a TCP communication is to be suspended,

Tₗₐₛₜ_{_{—}}ₜᵢₘₑ: a time interval for updating relay status information, and

Tₗᵢₙₖ: a time interval for updating communication link status information.

The present invention described above may be applied to relay apparatuses constituting the Internet. Moreover, it may be applied to relay apparatuses constituting a LAN.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A communication relay apparatus for connecting with an adjacent equipment employing a protocol in a lower layer, relaying communication employing a protocol in an upper layer, and when deciding that communication in the upper layer is suspended, releasing resources used by the protocol in the lower layer while retaining resources used by the protocol in an upper layer, thereby making effective use of resources, wherein said apparatus comprises:
a suspendable candidate link group determining device for determining a communication link group whose communication in an upper layer is suspended;
a link-incapable-of-handling-suspension excluding device for excluding, from said determined communication link group, a communication link to an adjacent equipment not having suspension capability of releasing resources for a lower layer while retaining resources for an upper layer when communication in the upper layer is suspended, and outputting information indicating a communication link group consisting of communication links that are not excluded as information indicating a communication link group to be brought into a suspended status; and
a suspending device for making control for causing a communication link group indicated by said output information to release resources for a lower layer for each communication link.

2. A communication relay apparatus according to claim 1, wherein said suspendable candidate link group determining device employs a fact that no communication in an upper layer has been carried over a period of time equal to or greater than a predetermined threshold as a criterion of decision that communication in an upper layer is suspended.

3. A communication relay apparatus according to claim 1, wherein said apparatus employs a connectionless-type protocol as a communication protocol in an upper layer to be relayed, and
said suspendable candidate link group determining device decides whether communication in an upper layer is suspended or not for each communication link established by a protocol in a lower layer to determine a communication link group whose communication in an upper layer is suspended.

4. A communication relay apparatus according to claim 1, wherein said apparatus employs a connection-type protocol as a communication protocol in an upper layer to be relayed, and
said suspendable candidate link group determining device decides whether communication in an upper layer is suspended or not for each communication connection established by a protocol in an upper layer to determine a communication connection group whose communication in an upper layer is in a suspended status, and determines a communication link group whose communication in an upper layer is suspended in whole based on the determined communication connection group.

5. A communication relay apparatus according to claim 1, wherein said link-incapable-of-handling-suspension excluding device decides whether an adjacent equipment has capability of releasing resources for a lower layer or not based on information preset within said apparatus.

6. A communication relay apparatus according to claim 1, wherein said link-incapable-of-handling-suspension excluding device decides whether an adjacent equipment has capability of releasing resources for a lower layer or not based on information contained in communication with the adjacent equipment according to a lower layer protocol.

7. A communication relay apparatus according to claim 1, wherein, in deciding whether an adjacent equipment has capability of releasing resources for a lower layer or not, said link-incapable-of-handling-suspension excluding device decides whether the adjacent equipment has capability of releasing resources for a lower layer or not based on a response from the adjacent equipment in response to an inquiry to the adjacent equipment by communication.

8. A communication relay apparatus according to claim 1, wherein, when it is not known that an adjacent equipment has capability of releasing resources for a lower layer or not, said link-incapable-of-handling-suspension excluding device decides that the adjacent equipment does not have said capability.

9. A communication relay apparatus according to claim 1, wherein said apparatus comprises:
a resumable link group determining device for determining, as a communication link group to be resumed, a communication link group consisting of communication links in which communication data in an upper layer contained in a communication link in a suspended status and to be transmitted through the communication link is received by said communication relay apparatus and is waiting for transmission; and
a resuming device for resuming a communication link by reserving lower layer resources again for each communication link contained in the communication link group determined by said resumable link group determining device.

10. A communication system provided with a plurality of communication relay apparatuses, each connecting with an adjacent equipment employing a protocol in a lower layer and relaying communication employing a protocol in an upper layer, wherein at least one communication relay apparatus comprises:
a suspendable candidate link group determining device for determining a communication link group whose communication in an upper layer is suspended;
a link-incapable-of-handling-suspension excluding device for excluding, from said determined communication link group, a communication link to an adjacent equipment not having suspension capability of releasing resources for a lower layer while retaining resources for an upper layer when communication in the upper layer is suspended, and outputting information indicating a communication link group consisting of communication links that are not excluded as information indicating a communication link group to be brought into a suspended status; and
a suspending device for making control for causing a communication link group indicated by said output information to release resources for a lower layer for each communication link, and
wherein said suspending device makes control for causing a communication link group indicated by said output information to release resources for a lower layer for each communication link, thereby making effective use of resources.

11. A resource releasing method applied to a communication relay apparatus for connecting with an adjacent equipment employing a protocol in a lower layer and relaying communication employing a protocol in an upper layer, and when deciding that communication in an upper layer is suspended, releasing resources used by the protocol in a lower layer while retaining resources used by the protocol in an upper layer, thereby making effective use of resources, wherein said method comprises steps of:
determining a communication link group whose communication in an upper layer is suspended;
excluding, from said determined communication link group, a communication link to an adjacent equipment not having suspension capability of releasing resources for a lower layer while retaining resources for an upper layer when communication in the upper layer is suspended; and
making control for causing a communication link group consisting of communication links that are not excluded to release resources for a lower layer for each communication link.

12. A resource releasing method according to claim 11, wherein said method comprises a step of, in determining a communication link group whose communication in an upper layer is suspended, employing a fact that no communication in an upper layer has been carried over a period of time equal to or greater than a predetermined threshold as a criterion of decision that communication in an upper layer is suspended.

13. A resource releasing method according to claim 11, wherein said method comprises steps of:
employing a connectionless-type protocol as a communication protocol in an upper layer to be relayed; and
in determining a communication link group whose communication in an upper layer is suspended, deciding whether communication in an upper layer is suspended or not for each communication link established by a protocol in a lower layer to determine a communication link group whose communication in an upper layer is suspended.

14. A resource releasing method according to claim 11, wherein said method comprises steps of:
employing a connection-type protocol as a communication protocol in an upper layer to be relayed; and
in determining a communication link group whose communication in an upper layer is suspended, deciding whether communication in an upper layer is suspended or not for each communication connection established by a protocol in an upper layer to determine a communication connection group whose communication in an upper layer is in a suspended status, and determining a communication link group whose communication in an upper layer is suspended in whole based on the determined communication connection group.

15. A resource releasing method according to claim 11, wherein said method comprises a step of, in excluding a communication link to an adjacent equipment not having suspension capability, deciding whether the adjacent equipment has capability of releasing resources for a lower layer or not based on information preset in said apparatus.

16. A resource releasing method according to claim 11, wherein said method comprises a step of, in excluding a communication link to an adjacent equipment not having suspension capability, deciding whether the adjacent equipment has capability of releasing resources for a lower layer or not based on information contained in communication with the adjacent equipment according to a lower layer protocol.

17. A resource releasing method according to claim 11, wherein said method comprises a step of, in deciding whether an adjacent equipment has capability of releasing resources for a lower layer or not, deciding whether the adjacent equipment has capability of releasing resources for a lower layer or not based on a response from the adjacent equipment in response to an inquiry to the adjacent equipment by communication.

18. A resource releasing method according to claim 11, wherein said method comprises a step of, in excluding a communication link to an adjacent equipment not having suspension capability, when it is not known that the adjacent equipment has capability of releasing resources for a lower layer or not, deciding that the adjacent equipment does not have said capability.

19. A resource releasing method according to claim 11, wherein said method comprises steps of:
determining, as a communication link group to be resumed, a communication link group consisting of communication links in which communication data in an upper layer contained in a communication link in a suspended status and to be transmitted through the communication link is received by said communication relay apparatus and is waiting for transmission; and
resuming a communication link by reserving lower layer resources again for each communication link contained in the determined communication link group.

20. A recording medium in which a program is recorded, wherein said program is incorporated into a communication relay apparatus for connecting with an adjacent equipment employing a protocol in a lower layer and relaying communication employing a protocol in an upper layer, and causes said communication relay apparatus to execute:
suspendable candidate link group determining processing for determining a communication link group whose communication in an upper layer is suspended;
link-incapable-of-handling-suspension excluding processing for excluding, from a communication link group determined by said suspendable candidate link group determining processing, a communication link to an adjacent equipment not having suspension capability of releasing resources for a lower layer while retaining resources for an upper layer when communication in the upper layer is suspended, and outputting information indicating a communication link group consisting of communication links that are not excluded as information indicating a communication link group to be brought into a suspended status; and
suspending processing for causing a communication link group indicated by information output in said link-incapable-of-handling-suspension excluding processing to release resources for a lower layer for each communication link.

21. A recording medium according to claim 20, wherein a program is recorded, which, in the suspendable candidate link group determining processing, employs a fact that no communication in an upper layer has been carried over a period of time equal to or greater than a predetermined threshold as a criterion of decision that communication in an upper layer is suspended.

22. A recording medium according to claim 20, wherein a program is recorded, which, when the communication relay apparatus employs a connectionless-type protocol as a communication protocol in an upper layer to be relayed, in the suspendable candidate link group determining processing, decides whether communication in an upper layer is suspended or not for each communication link established by a protocol in a lower layer, to determine a communication link group whose communication in an upper layer is suspended.

23. A recording medium according to claim 20, wherein a program is recorded, which, when the communication relay apparatus employs a connection-type protocol as a communication protocol in an upper layer to be relayed, in the suspendable candidate link group determining processing, decides whether communication in an upper layer is suspended or not for each communication connection established by a protocol in an upper layer to determine a communication connection group whose communication in an upper layer is in a suspended status, and determines a communication link group whose communication in an upper layer is suspended in whole based on the determined communication connection group.

24. A recording medium according to claim 20, wherein a program is recorded, which, in the link-incapable-of-handling-suspension excluding processing, decides whether an adjacent equipment has capability of releasing resources for a lower layer or not based on information preset within said apparatus.

25. A recording medium according to claim 20, wherein a program is recorded, which, in the link-incapable-of-handling-suspension excluding processing, decides whether an adjacent equipment has capability of releasing resources for a lower layer or not based on information contained in communication with the adjacent equipment according to a lower layer protocol.

26. A recording medium according to claim 20, wherein a program is recorded, which, in the link-incapable-of-handling-suspension excluding processing, in deciding whether an adjacent equipment has capability of releasing resources for a lower layer or not, decides whether the adjacent equipment has capability of releasing resources for a lower layer or not based on a response from the adjacent equipment in response to an inquiry to the adjacent equipment by communication.

27. A recording medium according to claim 20, wherein a program is recorded, which, in the link-incapable-of-handling-suspension excluding processing, when it is not known that an adjacent equipment has capability of releasing resources for a lower layer or not, decides that the adjacent equipment does not have said capability.

28. A recording medium according to claim 20, wherein a program is recorded, which executes:
resumable link group determining processing for determining, as a communication link group to be resumed, a communication link group consisting of communication links in which communication data in an upper layer contained in a communication link in a suspended status and to be transmitted through the communication link is received by said communication relay apparatus and is waiting for transmission; and
resuming processing for resuming a communication link by reserving lower layer resources again for each communication link contained in the communication link group determined by said resumable link group determining processing.
